(19) United States
(12) Patent Application Publication
(10) Pub. No.: US 2021/0051283 A1
(43) Pub. Date: Feb. 18, 2021

(54) IMAGE SENSORS HAVING ANALOG MEMORY CELLS FOR IMPROVED DYNAMIC RANGE

(71) Applicant: SEMICONDUCTOR COMPONENTS INDUSTRIES, LLC, Phoenix, AZ (US)

(72) Inventors: Nicholas Paul COWLEY, Wroughton (GB); Tomas GEURTS, Haasrode (BE); Chi Man KAN, Swindon (GB); Pawan GILHOTRA, San Jose, CA (US)

(73) Assignee: SEMICONDUCTOR COMPONENTS INDUSTRIES, LLC, Phoenix, AZ (US)

(21) Appl. No.: 16/667,201

(22) Filed: Oct. 29, 2019

Related U.S. Application Data
(60) Provisional application No. 62/885,698, filed on Aug. 12, 2019.

(51) Int. Cl. H04N 5/378; H04N 5/3745; H01L 27/146; H04N 5/355

(52) U.S. Cl. CPC H04N 5/378; H04N 5/37457; H01L 27/14612; H04N 5/3575; H01L 27/14645; H01L 27/14689; H04N 5/3559

(57) ABSTRACT

An image sensor may include an array of image pixels that is coupled to column readout circuitry, which may read out charge generated by the image pixels. The column readout circuitry may include a column amplifier having analog memory cells. The analog memory cells may include a high gain capacitor and a low gain capacitor coupled in parallel between a column of the image pixels and an input of the column amplifier. A feedback capacitor may be coupled between the input and an output of the column amplifier. High and low gain select switches respectively coupled to the high and low gain capacitors may allow for the output of high and low gain reset values and image signals, which may be used in correlated double sampling operations and which may increase the dynamic range of the image sensor.

### CROSS-REFERENCE TO RELATED APPLICATIONS

This application claims the benefit of U.S. Provisional Patent Application No. 62/885698, filed on Aug. 12, 2019, the entire contents of which is incorporated herein by reference.

### BACKGROUND

This relates generally to imaging devices, and more particularly, to imaging sensors that include analog memory cells in column readout amplifiers to improve correlated double sampling operations and increase the dynamic range of the image sensors.

Image sensors are commonly used in electronic devices such as cellular telephones, cameras, and computers to capture images. In a typical arrangement, an image sensor includes an array of image pixels arranged in pixel rows and pixel columns. Column readout circuitry may be coupled to each pixel column for reading out image signals from the image pixels.

Typical image pixels contain a photodiode for generating charge in response to incident light. Conventional imaging systems may have images with artifacts associated with low dynamic range. Scenes with bright and dark portions may produce artifacts in conventional image sensors, as portions of the low dynamic range images may be over exposed or under exposed. Image sensors may therefore be equipped with high dynamic range (HDR) functionality, where multiple images are captured with an image sensor with different exposure times. The images are later combined into a high dynamic range image, but this can introduce motion artifacts, especially in dynamic scenes with non-static objects, as well as a reduction in the frames-per-second captured by the image sensor. Alternatively, image sensors may read out the pixel output over multiple receive path gains. However, this method renders the imaging device unable to perform correlated double sampling operations for each gain, and it also reduces the frames-per-second captured by the images sensor.

It would therefore be desirable to be able to provide imaging devices with improved image sensors.

### BRIEF DESCRIPTION OF THE DRAWINGS

FIG. 1 is a diagram of an illustrative electronic device having an image sensor and processing circuitry for capturing images using an array of image pixels in accordance with an embodiment.

FIG. 2 is a diagram of an illustrative pixel array and associated readout circuitry for reading out image signals from the pixel array in accordance with an embodiment.

FIG. 3 is a circuit diagram of an illustrative image sensor pixel and column readout circuitry having analog memory cells with high and low gain capacitors on parallel readout signal paths coupled to a column amplifier in accordance with an embodiment.

FIG. 4 is a flow chart of illustrative steps of operating the illustrative image sensor pixel and column readout circuitry shown in FIG. 3 in accordance with an embodiment.

FIG. 5 is a flow chart of illustrative correlated double sampling operations that may be performed by the illustrative column readout circuitry in reading out image signals generated by the image sensor pixel shown in FIG. 3 in accordance with an embodiment.

FIG. 6 is a circuit diagram of an illustrative image sensor pixel and column readout circuitry having analog memory cells with high and low gain capacitors on parallel readout signal paths coupled to a column amplifier, a storage capacitor, and a gain buffer in accordance with an embodiment.

FIG. 7 is a circuit diagram of an illustrative image sensor pixel and column readout circuitry having analog memory cells with high and low gain capacitors on parallel readout signal paths coupled to a column amplifier, and mismatch compensation circuitry in accordance with an embodiment.

### DETAILED DESCRIPTION

Embodiments of the present invention relate to image sensors, and more particularly, to image sensors having column readout circuitry with analog memory cells to improve dynamic range and the corresponding readout operations of the image sensors. It will be recognized by one skilled in the art that the present exemplary embodiments may be practiced without some or all of these specific details. In other instances, well known operations have not been described in detail in order to not unnecessarily obscure the present embodiments.

Imaging systems having digital camera modules are widely used in electronic devices such as digital cameras, computers, cellular telephones, and other electronic devices. A digital camera module may include one or more image sensors that gather incoming light to capture an image. Image sensors may include arrays of image pixels. The pixels in the image sensors may include photosensitive elements such as photodiodes that convert the incoming light into electric charge. Image sensors may have any number of pixels (e.g., hundreds or thousands or more). A typical image sensor may, for example, have hundreds, thousands, or millions of pixels (e.g., megapixels). Image sensors may include control circuitry such as circuitry for operating the image pixels and readout circuitry for reading out image signals corresponding to the electric charge generated by the photosensitive elements.

Image sensor pixels may have improved dynamic range through the use of reading out image signals at high and low gain. In particular, the image sensor pixels may read out the image signals over parallel high and low gain signal paths that include analog memory cells with high and low gain capacitors. The high and low gain capacitors may be used to store the reset signals necessary to perform correlated double sampling operations on respective high gain and low gain image signals.

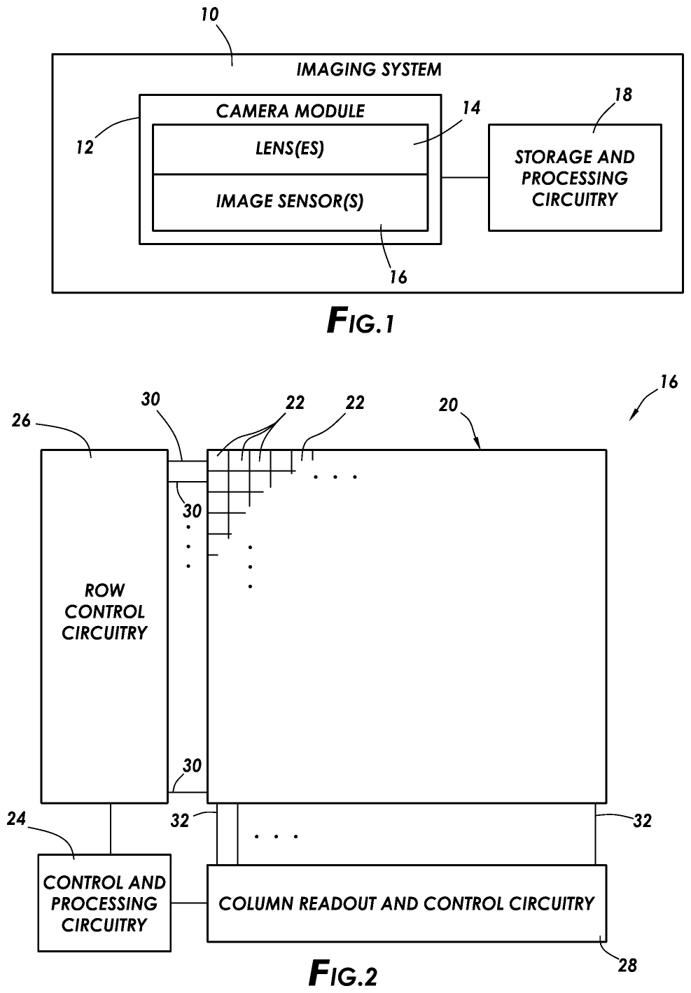

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

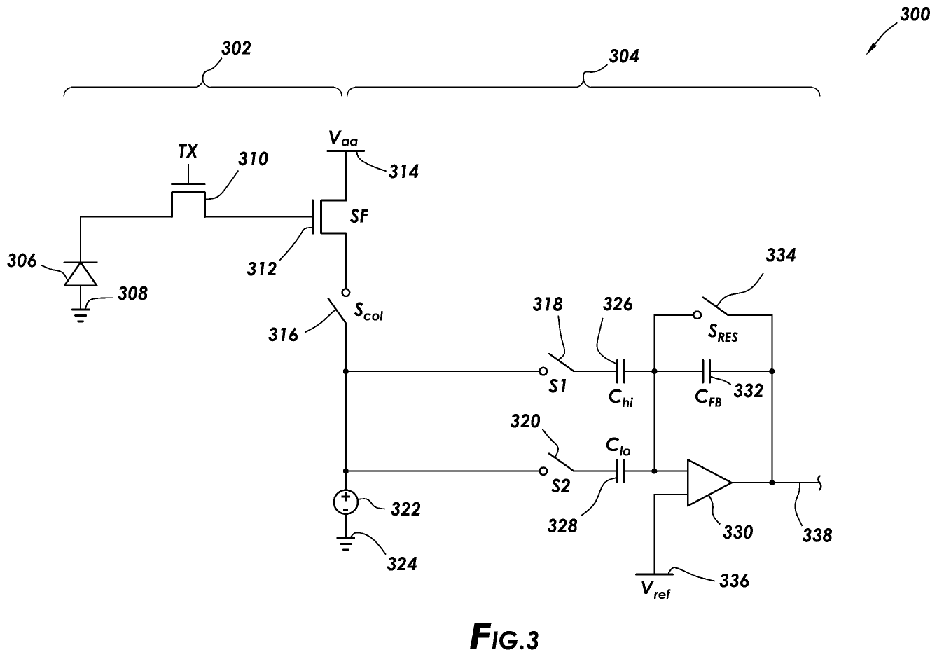

As shown in FIG. 2, image sensor 16 may include a pixel array 20 containing image sensor pixels 22 arranged in rows and columns (sometimes referred to herein as image pixels or pixels) and control and processing circuitry 24. Array 20 may contain, for example, hundreds or thousands of rows and columns of image sensor pixels 22. Control circuitry 24 may be coupled to row control circuitry 26 and image readout circuitry 28 (sometimes referred to as column control circuitry, column readout circuitry, readout circuitry, processing circuitry, or column decoder circuitry). Row control circuitry 26 may receive row addresses from control circuitry 24 and supply corresponding row control signals such as reset, row-select, charge transfer, dual conversion gain, and readout control signals to pixels 22 over row control paths 30. These row control signals may be used to enable dual conversion gain operations within image sensor 16, if desired. One or more conductive lines such as column lines 32 may be coupled to each column of pixels 22 in array 20. Column lines 32 may be used for reading out image signals from pixels 22 and for supplying bias signals (e.g., bias currents or bias voltages) to pixels 22. If desired, during pixel readout operations, a pixel row in array 20 may be selected using row control circuitry 26 and image signals generated by image pixels 22 in that pixel row can be read out along column lines 32.

Image readout circuitry 28 (sometimes referred to as column readout and control circuitry 28) may receive image signals (e.g., analog pixel values generated by pixels 22) over column lines 32. Image readout circuitry 28 may include sample-and-hold circuitry for sampling and temporarily storing image signals read out from array 20, amplifier circuitry, analog-to-digital conversion (ADC) circuitry, bias circuitry, column memory, latch circuitry for selectively enabling or disabling the column circuitry, or other circuitry that is coupled to one or more columns of pixels in array 20 for operating pixels 22 and for reading out image signals from pixels 22. Sample-and-hold circuitry in readout circuitry 28 may be used to read out charge generated by image pixels 22 using correlated double sampling operations. ADC circuitry in readout circuitry 28 may convert analog pixel values received from array 20 into corresponding digital pixel values (sometimes referred to as digital image data or digital pixel data). Image readout circuitry 28 may supply digital pixel data to control and processing circuitry 24 and/or processor 18 (FIG. 1) for pixels in one or more pixel columns.

If desired, image pixels 22 may include one or more photosensitive regions for generating charge in response to image light. Photosensitive regions within image pixels 22 may be arranged in rows and columns on array 20. Pixel array 20 may be provided with a color filter array having multiple color filter elements which allows a single image sensor to sample light of different colors. As an example, image sensor pixels such as the image pixels in array 20 may be provided with a color filter array which allows a single image sensor to sample red, green, and blue (RGB) light using corresponding red, green, and blue image sensor pixels arranged in a Bayer mosaic pattern. The Bayer mosaic pattern consists of a repeating unit cell of two-by-two image pixels, with two green image pixels diagonally opposite one another and adjacent to a red image pixel diagonally opposite to a blue image pixel. In another suitable example, the green pixels in a Bayer pattern are replaced by broadband image pixels having broadband color filter elements (e.g., clear color filter elements, yellow color filter elements, etc.). These examples are merely illustrative and, in general, color filter elements of any desired color and in any desired pattern may be formed over any desired number of image pixels 22.

Image sensor 16 may be configured to support a global shutter operation (e.g., pixels 22 may be operated in a global shutter mode). For example, the image pixels 22 in array 20 may each include a photodiode, floating diffusion region, and local charge storage region. With a global shutter scheme, all of the pixels in the image sensor are reset simultaneously. A charge transfer operation is then used to simultaneously transfer the charge collected in the photodiode of each image pixel to the associated charge storage region. Data from each storage region may then be read out on a per-row basis, for example. However, this is merely illustrative. In general, any desired read sequence may be used. For example, a rolling shutter operation, a pipelined readout operation, a non-pipelined readout operation, or any other desired readout operation may be utilized.

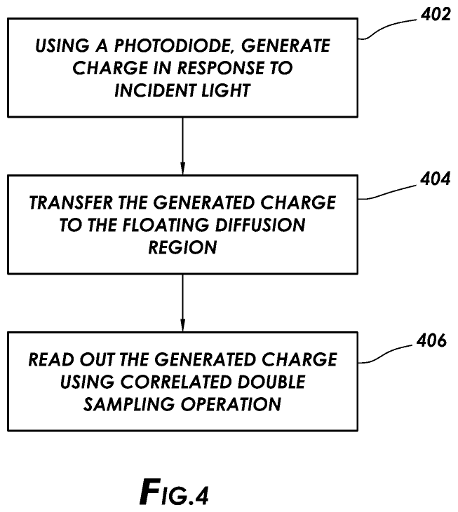

FIG. 3 is a circuit diagram of an image pixel and column readout circuitry having an analog memory cell for improved correlated double sampling readout operations. In particular, image sensor circuitry 300 may include image sensor pixel 302, which may correspond to one of the image pixels 22 shown in FIG. 2. As shown in FIG. 3, image pixel 300 may include photosensitive element 306. Photosensitive element 306 may be, for example, a photodiode. Photosensitive element 306 may have a first terminal connected to grounding structure 308. The second terminal of photosensitive element 306 may be coupled to transfer transistor 310. Transfer transistor 310 may be coupled to source-follower transistor 312, which may connect image pixel circuitry 302 to column readout circuitry 304. In particular, source-follower transistor 312 may have a gate coupled to transfer transistor 310, a first source-drain terminal coupled to voltage supply 314, and a second source-drain terminal coupled to column switch 316. Although not shown a source-follower reset transistor may be coupled between source-follow transistor 312 and voltage supply 314. The source-follower reset transistor may receive a control signal to close (e.g., turn the transistor on) and reset a floating diffusion associated with the gate of source follower transistor 312 to a reset voltage supplied by voltage supply 314. Column switch 316 may be coupled to high gain switch 318, low gain switch 320, and current source 322, which may be grounded to grounding structure 324. Grounding structure 324 may be the same structure as grounding structure 308, or they may be different structures. High gain switch 318 may be coupled to high gain capacitor 326 and low gain switch 320 may be coupled to low gain capacitor 328. High gain capacitor 326 and low gain capacitor 328 may be a part of analog memory cells that store a reset voltage for high and low gain correlated double sampling operations. The high and low gain capacitors may be coupled in parallel to column amplifier 330. Column amplifier 330 may include feedback capacitor 332 and reset switch 334. An input to column amplifier 330 may be coupled to reference voltage Vref from voltage supply 336, and the outputs of high gain capacitor 326, low gain capacitor 328, and feedback capacitor 332. The output of column amplifier 330 may be coupled to signal output line 338.

Although high gain capacitor 326 and low gain capacitor 328 have been shows in FIG. 3 as having switches coupled between the capacitors and the image pixel, this is merely illustrative. In general, capacitors 326 and 328 may be formed in any desired manner. For example, it may be desired to reduce parasitic effects and other switching artifacts. In one embodiment, high gain switch 318 and low gain switch 320 may be implemented on the opposite capacitor plate of respective capacitors 726 and 728 (e.g., each switch may be deployed between the capacitor and the feedback node). Alternatively, switches may be included on both sides of capacitors 726 and 728.

Photodiode 306 may generate charge (e.g., electrons) in response to receiving impinging photons. The amount of charge that is collected by photodiode 306 depends on the intensity of the impinging photons and the exposure duration (or integration time). Following the charge integration at photodiode 306, control signal TX may be asserted to turn on transfer transistor 310 and move the charge to source-follower transistor 312. Source-follower transistor 312 may have an associated floating diffusion (or other capacitive storage element associated with the gate of source-follower transistor 312), if desired. The charge may be converted to a voltage on the floating diffusion (or other capacitive element). In this way, the voltage may be reflective of the amount of light that was incident on photodiode 306.

Column readout circuitry 304 may then read out the voltage corresponding to the charge generated by photodiode 306. The readout may be performed at two gains, and correlated double sampling methods may be used to reduce the noise in each of the gain reads. During readout operations, the floating diffusion region may be reset to a reset voltage (Vres) using voltage source 314. The floating diffusion region may be reset prior to transferring the charge from photodiode 306. During reset operations, column switch 316 is closed and high gain switch 318, low gain switch 320, and reset switch 334 may be closed to set the voltage across high gain capacitor 326 and low gain capacitor 328 to Vres−Vref (where Vref is a reference voltage used by the column readout circuitry in performing correlated double sampling calculations), the voltage across feedback capacitor 332 to a reset voltage (which may be nominally 0V, as an example), and the output voltage 338 equal to reference voltage Vref. Reset switch 334 may be opened, and the reset may be read out from column amplifier 330 as Vref as a reset signal over signal output line 338. The voltage across high gain capacitor 326 and low gain capacitor 328 may contain the reset voltage (e.g., Vres−Vref). In particular, both the high and low gain capacitors will contain the same reset value. Therefore, in a single process, both read paths may be set to contain the rest value and the column amplifier output may be read.

Low gain switch 320 may then be opened and a pixel output signal (e.g., a signal corresponding to the charge generated by photodiode 306) may be transferred to the floating diffusion region (e.g., through transfer transistor 310), setting the voltage at source-follower transistor 312 to Vres−Vsig, where Vsig is a voltage corresponding to the charge generated by photodiode 306. Although column switch 316 may already be closed from the reset operation, column switch 316 may be closed at this point, and the signal voltage may be transferred to high gain capacitor 326, thereby causing a change in the charge stored at high gain capacitor 326. Charge correlating with the change in charge stored at high gain capacitor 326 may move into feedback capacitor 332, thereby changing the voltage associated with feedback capacitor 332 to a value inversely proportional to the voltage on the high gain capacitor. In this way, the voltage at feedback capacitor 332 may be inversely proportional to a voltage signal under high gain conditions. The signal on feedback capacitor 332 may be read out from column amplifier 330 as a high gain image signal over signal output line 338. This high gain image signal may be Vref−Vsig−Vres. Correlated double sampling operations may be used to remove noise from the high gain image signal by subtracting the Vref−Vres reset signal, leaving a readout of the signal at high gain.

High gain switch 318 may then be opened, reset switch 334 may be closed, and column amplifier output line 338 may be reset using voltage source 336 to Vref. Reset switch 334 may then be opened, and low gain switch 320 may be closed such that charge correlating with the change in charge stored at low gain capacitor 328 (e.g., a change in charge induced by the voltage from the floating diffusion region) may move into feedback capacitor 332, thereby changing the voltage associated with feedback capacitor 332 to a value inversely proportional to the voltage on the low gain capacitor. In this way, the voltage at feedback capacitor 332 may be inversely proportional to a voltage signal under low gain conditions. The signal on feedback capacitor 332 may be read out from column amplifier 330 as a low gain image signal over signal output line 338. This high gain image signal may be Vref−Vsig−Vres. Correlated double sampling operations may be used to remove noise from the low gain image signal by subtracting the Vref−Vres reset signal, leaving a readout of the signal at low gain.

Because high gain capacitor 326 and low gain capacitor 328 are coupled in parallel to both the column readout line (e.g., to source-follower transistor 312) and to column amplifier 330, capacitors 326 and 328 may receive the same signal generated by photodiode 306, and the same reset signal may be correlated to the signals that pass through capacitors 326 and 328 during the reset process. Therefore, both the high and low gain reads may be performed using correlated double sampling (e.g., the reset value read out in the first read can be used to correct noise in both the high gain image signal and the low gain image signal) with only three reads. Additionally, multiple image frames may not need to be taken, thereby improving the frame rate of the image sensor.

Although circuitry 300 has been illustrated with image sensor pixel 302, this is merely illustrative. In general, any desired pixel circuitry with any desired number of photosensitive elements and transistors may be used to produce charge in response to incident light and transfer the produced charge to be read out. The pixel circuitry may have three transistors, four transistors, five transistors, or more than five transistors, if desired. Additionally, image sensor pixel 302 may have any number of pixel gain paths coupled to the one or more photosensitive elements. For example, image sensor pixel 302 may have two or more, three or more, four or more, or ten or fewer source-follower transistors coupled to two or more, three or more four or more, or ten or fewer photosensitive elements to read out image signals at multiple gains. However, this is merely illustrative. In general, image sensor pixel 302 may have any number of photosensitive elements coupled to any number of read paths.

In some embodiments, although not illustrated, pixel 302 may include at least one intermediate storage node (e.g., between photodiode 306 and the floating diffusion). For example, the intermediate storage node may be used to enable global shutter operations.

All of the switches described in connection with FIG. 3 and the other figures herein may be make-before-break type switches or may be break-before-make type switches. Moreover, although column switch 316, high gain select switch 318, and low gain select switch 320 are illustrated as switches, they may be implemented as transistors, if desired. If implemented as transistors, instead of closing the switches, the control signal may be used to activate the desired transistor and allow charge to flow through the transistor.

The circuitry shown in FIG. 3 is not limited to high gain capacitor 326 and low gain capacitor 328. In general, any number of gain capacitors may be used to produce any number of gain reads. As an example, a first gain capacitor, a second gain capacitor, and a third gain capacitor (and associated first, second, and third gain switches) may be used to provide for a three gain read of the image signal. Generally, N gain capacitors may be used to provide for N gain reads of the image signal. Alternatively or additionally, multiple capacitors can be used in parallel to read out signals at the same gain, but with different noise. For example, capacitor 326 may be used for readout at a first gain with a first noise and capacitor 328 (and an additional capacitor in series, if desired) may be used for readout at the first gain with a second noise. In this case, additional capacitors may be used in parallel with capacitors 326 and 328 for readout at a second gain at a first noise and readout at the second gain at a second noise. However, this is merely illustrative. In general, any desired number of capacitors may be used in any desired arrangement to provide readout operations at different gains and/or noises.

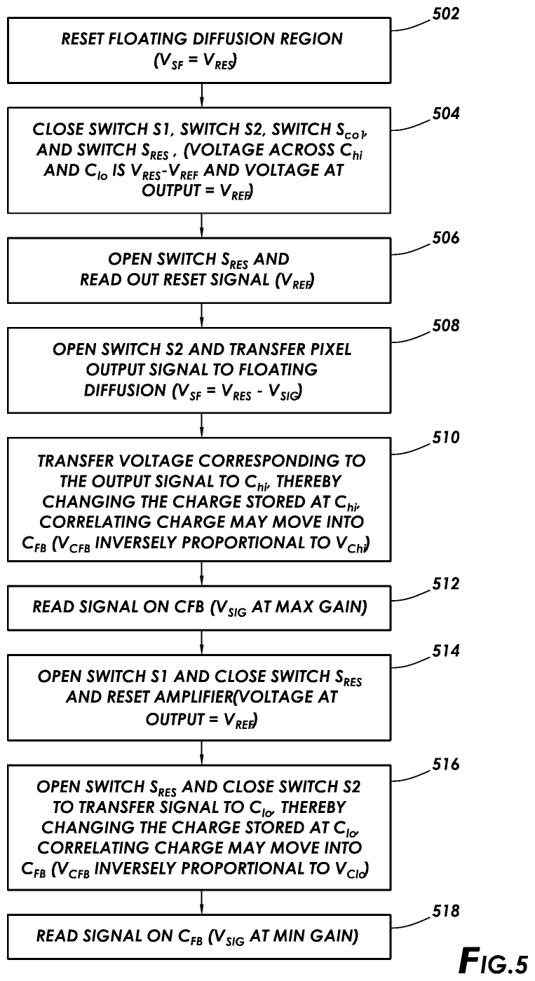

A flow chart showing illustrative steps that may be used in operating pixel and readout circuitry, such as pixel and readout circuitry 300 shown in FIG. 3, is shown in FIG. 4. At step 402, a photodiode, such as photodiode 306, may be used to generate charge in response to incident light. Although a single photodiode has been shown in FIG. 3, pixel 302 may include two photodiodes, three photodiodes, or four photodiodes, as examples. In general, pixel 302 may have any number of photodiodes that generate charge in response to incident light.

At step 404, transfer signal TX may be asserted to activate transfer transistor 310 and transfer the generated charge to the floating diffusion (or other capacitive element associated with source-follower transistor 312), which may convert the generated charge to a corresponding voltage. Although a transfer transistor and a source-follower transistor have been shown in FIG. 3, pixel 302 may include any desired number of transistors. If pixel 302 has an intermediate storage node (e.g., between photodiode 306 and the floating diffusion) global shutter readout operations may be used, and more steps may be required to transfer the charge from the photodiode to the floating diffusion. However, this is merely illustrative. In general, charge may be readout from photodiode 306 and transferred through any desired intermediate circuitry to the floating diffusion.

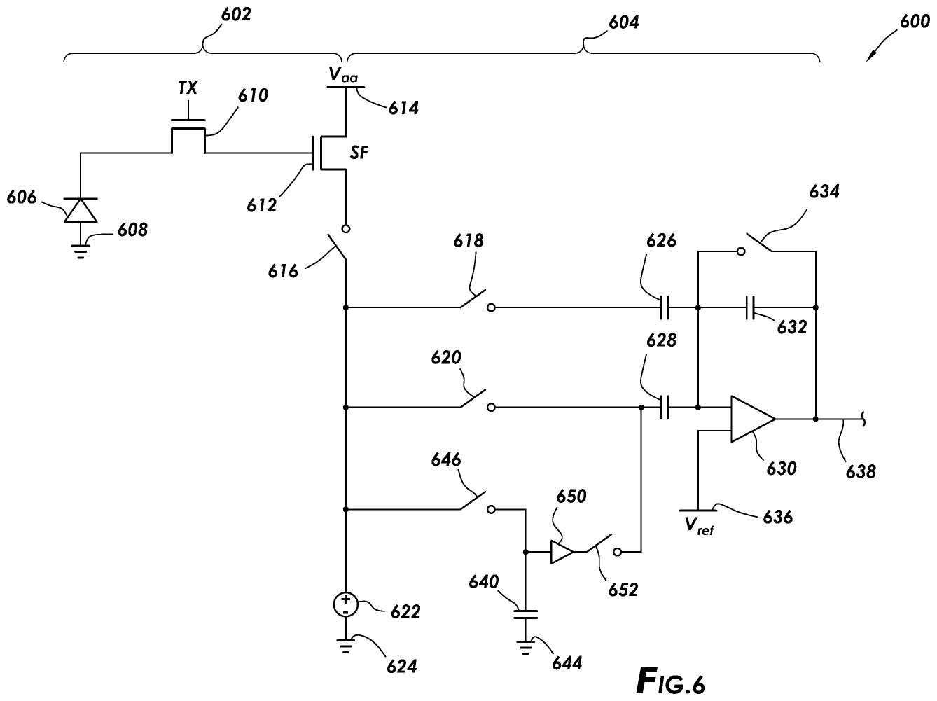

At step 406, the generated charge may be read out over column readout circuitry 304 using correlated double sampling operations. Using correlated double sampling may reduce noise in the read out image signal. More detailed read out steps, including the correlated double sampling operations, are shown in FIG. 5.

Illustrative steps of operation for column readout circuitry, such as column readout circuitry 304 of FIG. 3, are shown in FIG. 5. At step 502, the floating diffusion region (or other capacitive element associated with source-follower transistor 312) may be reset to a reset voltage using voltage supply 314. The output voltage at the source-follower transistor may be equal to Vres.

At step 504, high gain select switch S1, low gain select switch S2, column switch Scol, and reset switch Sres may be closed. By closing these switches, the voltage across high gain capacitor Chi and low gain capacitor Clo may be set to Vres−Vref, the voltage across feedback capacitor Cfb may be set to nominally 0V (or other desired reset voltage), and the voltage at output line 338 may be equal to Vref. As shown in FIG. 3, Vref may be a voltage supplied by voltage supply 336 to column amplifier 330 to be used during correlated double sampling calculations.

At step 506, switch Sres may be opened, and a reset value may be read out through column amplifier 330. In particular, Vref may be read out as a reset signal. This reset signal may be used by processing circuitry to remove noise from the image signals read out later by the column readout circuitry.

At step 508, switch S2 may be opened and a pixel output signal (e.g., a signal corresponding to the charge generated by photodiode 306) may be transferred to the floating diffusion region (e.g., through transfer transistor 310), setting the voltage at source-follower transistor 312 to Vres−Vsig, where Vsig is a voltage corresponding to the charge generated by photodiode 306.

At step 510, the voltage corresponding to the charge generated by photodiode 306 may be transferred to high gain capacitor Chi, thereby causing a change in the charge stored at high gain capacitor Chi. Charge correlating with the change in charge stored at high gain capacitor Chi may move into feedback capacitor Cfb, thereby changing the voltage associated with feedback capacitor Cfb to a value inversely proportional to the voltage on the high gain capacitor. In this way, the voltage at feedback capacitor Cfb may be inversely proportional to a voltage signal under high gain conditions.

At step 512, the signal on feedback capacitor Cfb may be read out from column amplifier 330. In particular, the read out signal may represent the image signal voltage at high gain. In other words, a high gain image signal is read out. This high gain image signal may be Vref−Vsig−Vres. Correlated double sampling operations may be used with the high gain image signal and the reset signal to subtract Vref−Vres, leaving a readout of the signal at high gain.

At step 514, high gain select switch S1 may be opened and reset switch Sres may be closed. Column amplifier 330 (including feedback capacitor Cfb) may be reset. The voltage on feedback capacitor Cfb may be set to nominally 0V (or other desired reset voltage), and the voltage at output line 338 may be equal to Vref.

At step 516, reset switch Sres may be opened and low gain select switch S2 may be closed to transfer the image signal to low gain capacitor Clo such that charge correlating with the change in charge stored at low gain capacitor Clo may move into feedback capacitor Cfb, thereby changing the voltage associated with feedback capacitor Cfb to a value inversely proportional to the voltage on the low gain capacitor. In this way, the voltage at feedback capacitor Cfb may be inversely proportional to a voltage signal under low gain conditions.

At step 518, the signal on feedback capacitor Cfb may be read out from column amplifier 330. In particular, the read out signal may represent the image signal voltage at low gain. In other words, a low gain image signal is read out. This low gain image signal may be Vref−Vsig−Vres. Correlated double sampling operations may be used with the low gain image signal and the reset signal to subtract Vref−Vres, leaving a readout of the signal at low gain.

Although the method of FIG. 5 is described for the operation of column readout circuitry having two gain capacitors (e.g., the high gain and low gain capacitors of FIG. 3), this is merely illustrative. In general, column readout circuitry may have any number of desired gain capacitors, and the image signal read out steps of FIG. 5 (e.g., steps 514-518) may be repeated for any additional gain capacitors to provide additional reads at different gains. Moreover, the methods shown in FIGS. 4 and 5 have described the operation of an image pixel and corresponding column readout circuitry for reading out charge generated by a single pixel in a single image frame. These methods may be repeated as necessary to read out the signals generated by all pixels in an array of pixels (such as array 20 of FIG. 2) and to read out signals in subsequent image frames.

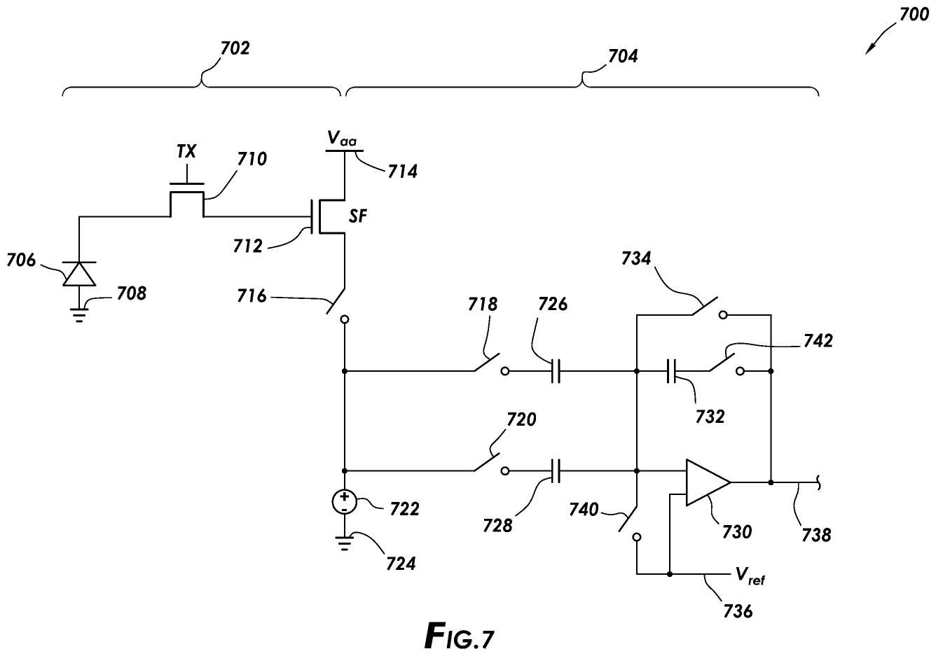

The method of FIG. 5 relies on the analog storage of the reset values throughout the high and low gain reads. Because the reset values are stored in this way, the reset signal may be used to reduce the noise in both the high and low gain image signals, and the image signal may only be transferred from the image pixel a single time (e.g., the image signal may correspond to a single image frame). However, this method relies on there being minimal leakage in each of the capacitors in the column readout circuitry. In some cases, it may be desired to reduce the leakage in the low gain capacitor, as it is required to hold the reset voltage the longest (e.g., while the high gain signal is being read out). An example of a circuit that reduces the leakage of the low gain capacitor is shown in FIG. 6.

As shown in FIG. 6, image sensor circuitry 600 may include image sensor pixel 602 and column readout circuitry 604. Image sensor pixel 602 may be substantially similar to that described in connection with image sensor pixel 302 of FIG. 3. For example, image sensor pixel 602 may include photodiode 606, which generates charge in response to incident light, coupled between ground 608 and transfer transistor 610. Transfer transistor 310 may further be coupled to a gate of source-follower transistor 612. However, this is merely illustrative. In general, any desired image pixel circuitry may be used with any number of photodiodes and transistors. For example, an image sensor having two or more, three or more, or six or fewer photodiodes and three or more, four or more, five or more, or seven or fewer transistors may be used. Column switch 616 may couple a source-drain terminal of source-follower transistor 612 to column readout circuitry 604.

Column readout circuitry 604 may include the same components as those described in connection with column readout circuitry 304 of FIG. 3. In particular, column readout circuitry 604 may include high gain select switch 618, high gain capacitor 626, low gain select switch 620, low gain capacitor 628, column amplifier 630, feedback capacitor 632, and reset switch 634. Each of these components may be operated substantially the same as those described in connection with FIG. 3.

Additionally, column readout circuitry 604 may include storage capacitor 640 coupled to low gain capacitor 628 through switch 652 and unity gain buffer 650. Storage capacitor 640 may allow for more storage than low gain capacitor 628 alone, thereby reducing leakage prior to reading out the low gain image signal.

During readout operations, the floating diffusion region may be reset to a reset voltage (Vres) using voltage source 614 (e.g., a reset transistor between source-follower transistor 612 and voltage source 614 may short the gate of source-follower transistor 612 to the voltage source 614). Column switch 616 is closed and high gain switch 618, low gain switch 620, storage switch 646, and reset switch 634 may be closed to set the voltage across high gain capacitor 626, low gain capacitor 628 to Vres−Vref (where Vref is a reference voltage used by the column readout circuitry in performing correlated double sampling calculations), the voltage across storage capacitor 640 to Vres, the voltage across feedback capacitor 632 to a reset voltage (which may be nominally 0V, as an example), and the output voltage 638 equal to reference voltage Vref. Optionally, switch 652 may also be closed at this time. Reset switch 634 may then be opened, and the reset may be read out from column amplifier 630 as Vref as a reset signal over signal output line 638. The voltage across high gain capacitor 626 and low gain capacitor 628 may contain the reset voltage (e.g., Vres−Vref). In particular, both the high and low gain capacitors will contain the same reset value. Therefore, in a single process, both read paths may be set to contain the rest value and the column amplifier output may be read.

Low gain switch 620 and storage switch 646 may then be opened, and switch 652 may be closed (if not closed previously) to hold the voltage on low gain capacitor 628 to the reset value stored on storage capacitor 640. A pixel output signal (e.g., a signal corresponding to the charge generated by photodiode 606) may be transferred to the floating diffusion region, setting the voltage at source-follower transistor 612 to Vres−Vsig, where Vsig is a voltage corresponding to the charge generated by photodiode 606. Although column switch 616 may already be closed from the reset operation, column switch 616 may be closed at this point, and the signal voltage may be transferred to high gain capacitor 626, thereby causing a change in the charge stored at high gain capacitor 626. Charge correlating with the change in charge stored at high gain capacitor 326 may move into feedback capacitor 632, thereby changing the voltage associated with feedback capacitor 632 to a value inversely proportional to the voltage on the high gain capacitor. In this way, the voltage at feedback capacitor 632 may be inversely proportional to a voltage signal under high gain conditions. The signal on feedback capacitor 632 may be read out from column amplifier 630 as a high gain image signal over signal output line 638. This high gain image signal may be Vref−Vsig−Vres. Correlated double sampling operations may be used with the high gain image signal and the reset signal to subtract Vref−Vres, leaving a readout of the signal at high gain.

High gain switch 618 may then be opened, reset switch 634 may be closed, and column amplifier 630 may be reset using voltage source 636, setting output 638 to Vref. Reset switch 634 and additional switch 652 may then be opened, and low gain switch 620 may be closed to transfer the pixel output signal to low gain capacitor 628, such that charge correlating with the change in charge stored at low gain capacitor 628 may move into feedback capacitor 632, thereby changing the voltage associated with feedback capacitor 632 to a value inversely proportional to the voltage on the low gain capacitor. In this way, the voltage at feedback capacitor 632 may be inversely proportional to a voltage signal under low gain conditions. The signal on feedback capacitor 632 may be read out from column amplifier 630 as a low gain image signal over signal output line 638.

While FIG. 6 is one example of reducing leakage in the high and low gain capacitors, this is merely illustrative. In general, any desired method/technique of reducing leakage may be used.

Although using an additional storage capacitor may add noise and degrade correlation of the low gain signal, it may also reduce the amount of leakage during the high gain read out operations. Therefore, if the reset voltage needs to be held a long time (e.g., if the high gain read will take too long to hold the reset voltage for the low gain readout constant), it may be desired to use an additional storage capacitor, such as storage capacitor 640 of FIG. 6.

If three or more read paths are included then each additional path may have an equivalent switch to switch 652 so that each path can be held at the reset value stored on storage capacitor 640 until it is required to perform a signal sample when it is then released in a similar manner to above.

Additionally, in some embodiments, it may be desired to calibrate the column amplifier between readout (e.g., during the reset phase) to reduce any mismatch errors within the amplifier. Illustrative circuitry that can be used to perform calibration of the column amplifier is shown in FIG. 7.

As shown in FIG. 7, circuitry 702 includes pixel circuitry 702 and column readout circuitry 704. Pixel circuitry 702 may correspond to pixel circuitry 302 of FIG. 3 and pixel circuitry 602 of FIG. 6. However, this is merely illustrative. In general, any pixel circuitry may be used.

Column readout circuitry 704 may include the same components as those described in connection with column readout circuitry 304 of FIG. 3. In particular, column readout circuitry 704 may include high gain select switch 718, high gain capacitor 726, low gain select switch 720, low gain capacitor 728, column amplifier 730, feedback capacitor 732, and reset switch 734. Each of these components may be operated substantially the same as those described in connection with FIG. 3.

Additionally, column readout circuitry 704 may include first calibration switch 742 and second calibration switch 740. Prior to the reset phase, such as steps 502-506 of FIG. 5, calibration of column amplifier 730 may be performed. In particular, during calibration, first calibration switch 742 and second calibration switch 740 may be closed, and reset switch 734 may be opened. Second calibration switch 740 may short the inputs of column amplifier 730. Because first calibration switch 742 is closed, feedback capacitor 732 may be charged to a voltage corresponding to any voltage mismatch within column amplifier 730. First and second calibration switches 742 and 740 may then be opened, and reset switch 734 may be closed. Reset operations may then proceed as previously described in connection with steps 502-506 of FIG. 5, but with first calibration switch 742 open. In particular, the floating diffusion may be reset to a voltage using voltage supply 714. Then, high gain select switch 718, low gain select switch 720, and reset switch 734 may be closed. Reset switch 734 may then be opened and the reset voltage read out.

Generally, a mismatch may occur when the reset switch is opened at the end of the reset operations. However, because first calibration switch 742 is open, feedback capacitor 732 is not connected to the output of column amplifier 730 (which has been precharged to the mismatch voltage of column amplifier 730). Therefore, when reset switch 734 is opened and first calibration switch is closed to read out the voltage, the mismatch voltage of column amplifier 730 is accounted for, and no charge transfer occurs.

Column readout circuitry 706 may then proceed with reading out the high and low gain signals as discussed above in connection with FIG. 3 and in connection with steps 508-518 of FIG. 5.

Various embodiments have been described illustrating image sensors having column readout circuitry with analog memory cells that may increase the dynamic range of the image sensors.

In various embodiments of the present invention, an image sensor may include an image sensor pixel having a photodiode (or other photosensitive element) that generates charge in response to incident light and column readout circuitry coupled to the image sensor pixel to receive the generated charge. The column readout circuitry may include a column amplifier and an analog memory cell. A first analog memory cell may include a first capacitor coupled to an input of the column amplifier and configured to store a reset voltage for readout operations at a first gain, and a second analog memory cell may include a second gain capacitor coupled to the input of the column amplifier in parallel with the first gain capacitor and configured to store the reset voltage for readout operations at a second gain.

In some embodiments, the column amplifier may include a reset switch and a feedback capacitor coupled in parallel between the input and an output of the column amplifier. The image sensor may further include a first gain select switch coupled between the first gain capacitor and the image sensor pixel and a second gain select switch coupled between the second gain capacitor and the image sensor pixel. The image sensor pixel may include a source-follower transistor coupled to the photodiode through a transfer transistor. The first gain select switch and the second gain select switch may both be coupled to the source-follow transistor.

The first gain select switch, the second gain select switch, and the reset switch may be closed during a reset operation. The first gain select switch may be closed and both the second gain select switch and the reset switch may be open during the first gain readout. The second gain select switch may be closed and both the first gain select switch and the reset switch may be open during the second gain readout.

The image sensor may further include a storage capacitor coupled between the image sensor pixel and the second gain capacitor in parallel with the second gain select switch. The storage capacitor may provide additional storage for the reset voltage for the readout operations at the second gain during the first gain readout.

In some embodiments, the image sensor may further include a first calibration switch coupled between the feedback capacitor and the output of the column amplifier, and a second calibration switch coupled to the input of the column amplifier. The first and second calibration switches may be used during the reset operation to reduce mismatch error within the column amplifier.

In various embodiments, a method of operating an image sensor having an image pixel and column readout circuitry with a column amplifier having a feedback capacitor coupled between an input and an output of the column amplifier, a first analog memory cell that includes a high gain capacitor coupled to the input of the column amplifier, and a second analog memory cell that includes a low gain capacitor coupled to the input of the column amplifier in parallel with the high gain capacitor, may include resetting the high gain capacitor, the low gain capacitor, and a feedback capacitor of the analog memory cell. Using the high gain capacitor, a signal from the image pixel may be read out as a high gain image signal. Using the low gain capacitor, the signal from the image pixel may be read out as a low gain image signal.

Resetting the high gain capacitor, the low gain capacitor, and a feedback capacitor may include closing a high gain select switch coupled between the high gain capacitor and the image pixel, closing a low gain select switch coupled between the low gain capacitor and the image pixel, closing a reset switch coupled between the input and output of the column amplifier in parallel with the feedback capacitor, and setting the high gain capacitor, the low gain capacitor, and the feedback capacitor to a reset voltage. Reading out the signal from the image pixel as the high gain image signal may include opening the low gain select switch and the reset switch, transferring the signal from the image pixel to the high gain capacitor and the feedback capacitor, and reading out the signal as the high gain image signal. Reading out the signal from the image pixel as the low gain image signal comprises opening the high gain select switch and closing the reset switch to reset the column amplifier, opening the reset switch and closing the low gain select switch to transfer the signal to the low gain capacitor and the feedback capacitor, and reading out the signal as the low gain image signal.

In some embodiments, the method may further include closing a storage switch to set an additional storage capacitor to the first rest voltage while closing the low gain select switch to transfer the signal. The method may also include calibrating the column amplifier using a first calibration switch coupled between the output of the column amplifier and the feedback capacitor and a second calibration switch coupled to the input of the column amplifier prior to resetting the high gain capacitor, the low gain capacitor, and a feedback capacitor of the analog memory cell. Calibrating the column amplifier may include closing the first and second calibration switches and opening the reset switch and opening the first and second calibration switches and closing the rest switch.

In various embodiments, an image sensor may include an array of pixels that are configured to generate charge in response to incident light. Each pixel of the array of pixels may include a photodiode that is configured to generate the charge, and a transfer transistor coupled to the photodiode and configured to transfer the charge to a source-follower transistor. Column readout circuitry may be coupled to each source-follower transistor and may be configured to receive the generated charge from the given pixel. The column readout circuitry may include a first analog memory cell that includes a first gain capacitor that stores a reset voltage for readout operations at a first gain and a second analog memory cell that includes a second gain capacitor in parallel with the first gain capacitor that stores the reset voltage for readout operations at a second gain. The column readout circuitry may also include a column amplifier having a feedback capacitor and a reset switch coupled in parallel between an input and an output of the column amplifier. The first and second gain capacitors may be coupled to the input of the column amplifier.

In some embodiments, the image sensor may further include a column switch coupled to the source-follower transistor, a high gain select switch coupled between the high gain capacitor and the column switch, and a low gain select switch coupled between the low gain capacitor and the column switch. The high gain readout and the low gain readout may be configured to be read out using first and second correlated double sampling operations. A single reset signal may be used for both the first correlated double sampling operation and the second correlated double sampling operation. The image sensor may also include at least one additional gain capacitor coupled to the input of the column amplifier. The at least one additional gain capacitor may store the reset voltage for at least one additional readout operation at the first gain.

The foregoing is merely illustrative and various modifications can be made to the described embodiments. The foregoing embodiments may be implemented individually or in any combination.

What is claimed is:

1. An image sensor comprising:
an image sensor pixel having a photodiode that generates charge in response to incident light; and
column readout circuitry coupled to the image sensor pixel to receive the generated charge, wherein the column readout circuitry comprises:
a column amplifier; and
a first analog memory cell coupled between the column amplifier and the image sensor pixel, the first analog memory cell comprising a first gain capacitor coupled to an input of the column amplifier, wherein the first gain capacitor is configured to store a reset voltage for readout operations at a first gain, and
a second analog memory cell coupled between the column amplifier and the image sensor pixel, the second analog memory cell comprising a second gain capacitor coupled to the input of the column amplifier in parallel with the first gain capacitor, wherein the second gain capacitor is configured to store the reset voltage for readout operations at a second gain.

2. The image sensor defined in claim 1 wherein the column amplifier comprises a reset switch and a feedback capacitor coupled in parallel between the input and an output of the column amplifier.

3. The image sensor defined in claim 2 further comprising a first gain select switch coupled between the first gain capacitor and the image sensor pixel and a second gain select switch coupled between the second gain capacitor and the image sensor pixel.

4. The image sensor defined in claim 3 wherein the image sensor pixel comprises a source-follower transistor coupled to the photodiode through a transfer transistor, wherein the first gain select switch and the second gain select switch are both coupled to the source-follower transistor.

5. The image sensor defined in claim 4 wherein the first gain select switch, the second gain select switch, and the reset switch are closed during a reset operation, wherein the first gain select switch is closed and the second gain select switch and the reset switch are open during the first gain readout, and wherein the second gain select switch is closed and the first gain select switch and the reset switch are open during the second gain readout.

6. The image sensor defined in claim 5 further comprising a storage capacitor coupled between the image sensor pixel and the second gain capacitor in parallel with the second gain select switch.

7. The image sensor defined in claim 6 wherein the storage capacitor provides additional storage for the reset voltage for the readout operations at the second gain during the first gain readout.

8. The image sensor defined in claim 5 further comprising a first calibration switch coupled between the feedback capacitor and the output of the column amplifier and a second calibration switch coupled to the input of the column amplifier.

9. The image sensor defined in claim 8 wherein the first and second calibration switches are configured to be used during the reset operation to reduce mismatch error within the column amplifier.

10. A method of operating an image sensor having an image pixel and column readout circuitry with a column amplifier having a feedback capacitor coupled between an input and an output of the column amplifier, a first analog memory cell comprising a high gain capacitor coupled to the input of the column amplifier, and a second analog memory cell comprising a low gain capacitor coupled to the input of the column amplifier in parallel with the high gain capacitor, the method comprising:
resetting the high gain capacitor, the low gain capacitor, and the feedback capacitor;
using the high gain capacitor, reading out a signal from the image pixel as a high gain image signal; and
using the low gain capacitor, reading out the signal from the image pixel as a low gain image signal.

11. The method defined in claim 10 wherein resetting the high gain capacitor, the low gain capacitor, and a feedback capacitor comprises closing a high gain select switch coupled between the high gain capacitor and the image pixel, closing a low gain select switch coupled between the low gain capacitor and the image pixel, closing a reset switch coupled between the input and output of the column amplifier in parallel with the feedback capacitor, and setting the high gain capacitor and the low gain capacitor to a first reset voltage and the feedback capacitor to a second reset voltage that is different from the first reset voltage.

12. The method defined in claim 11 wherein reading out the signal from the image pixel as the high gain image signal comprises opening the low gain select switch and the reset switch, transferring the signal to the feedback capacitor, and reading out the signal as the high gain image signal.

13. The method defined in claim 12 wherein reading out the signal from the image pixel as the low gain image signal comprises opening the high gain select switch and closing the reset switch, resetting the column amplifier to a reset voltage, opening the reset switch and closing the low gain select switch to transfer the signal to the feedback capacitor, and reading out the signal as the low gain image signal.

14. The method defined in claim 13 further comprising:
while resetting the high gain capacitor, the low gain capacitor, and the feedback capacitor, closing a storage switch to set an additional storage capacitor to the first reset voltage.

15. The method defined in claim 14 further comprising:
prior to resetting the high gain capacitor, the low gain capacitor, and a feedback capacitor of the analog memory cell, calibrating the column amplifier using a first calibration switch coupled between the output of the column amplifier and the feedback capacitor and a second calibration switch coupled to the input of the column amplifier, wherein calibrating the column amplifier comprises:
closing the first and second calibration switches and opening the reset switch; and
opening the first and second calibration switches and closing the rest switch.

16. An image sensor comprising:
an array of pixels having rows and columns of pixels that are configured to generate charge in response to incident light, wherein each pixel of the array of pixels comprises a photodiode that is configured to generate the charge, a transfer transistor coupled to the photodiode and configured to transfer the charge to a floating diffusion associated with a gate of a source-follower transistor;
column readout circuitry coupled to each column of image pixels and configured to receive the generated charge from each column, wherein the column readout circuitry comprises:
a first gain capacitor configured to store a reset voltage for readout operations at a first gain,
a second gain capacitor in parallel with the first gain capacitor and configured to store the reset voltage for readout operations at a second gain, and
a column amplifier comprising a feedback capacitor and a reset switch coupled in parallel between an input and an output of the column amplifier, wherein the first and second gain capacitors are coupled to the input of the column amplifier.

17. The image sensor defined in claim 16 further comprising:
a column switch coupled to the source-follower transistor;
a first gain select switch coupled between the first gain capacitor and the column switch; and
a second gain select switch coupled between the second gain capacitor and the column switch.

18. The image sensor defined in claim 16 wherein the first gain readout and the second gain readout are configured to be read out using first and second correlated double sampling operations.

19. The image sensor defined in claim 19 wherein a single reset signal is configured to be used for both the first correlated double sampling operation and the second correlated double sampling operation.

20. The image sensor defined in claim 16 further comprising at least one additional gain capacitor coupled to the input of the column amplifier and configured to store the reset voltage for at least one additional readout operation at the first gain.
